(19) United States
(12) Patent Application Publication
(10) Pub. No.: US 2017/0004710 A1
(43) Pub. Date: Jan. 5, 2017

(54) Intelligent Parking Management

(71) Applicants: Kristen Dozono, Portland, OR (US); Michelle Craig, Vancouver, WA (US)

(72) Inventors: Kristen Dozono, Portland, OR (US); Michelle Craig, Vancouver, WA (US)

(21) Appl. No.: 15/197,757

(22) Filed: Jun. 30, 2016

Related U.S. Application Data
(60) Provisional application No. 62/187,218, filed on Jun. 30, 2015.

(51) Int. Cl. G08G 1/14; G06Q 20/40; G07B 15/02

(52) U.S. Cl. CPC G08G 1/144; G07B 15/02; G06Q 20/40

(57) ABSTRACT

Technologies and implementations for an intelligent vehicle parking system are generally disclosed.

### RELATED APPLICATION

This application claims benefit of priority to U.S. Provisional Patent Application Ser. No. 62/187,218 filed on Jun. 30, 2015, titled METHODS, SYSTEMS AND APPARATUS FOR SMART PARKING, which is incorporated herein by reference in its entirety.

### INFORMATION

Unless otherwise indicated herein, the approaches described in this section are not prior art to the claims in this application and are not admitted to be prior art by inclusion in this section.

There may be challenges to parking a vehicle today. For example, in urban areas, where parking spaces may be limited, finding a parking space may be difficult and frustrating. Even after being fortunate enough to find a parking space, some parking spaces may include interacting with a parking meter system. Interacting with a parking meter system may have its own challenges. For example, some parking meter systems may include using physical printed proof of purchase to be placed on a vehicle. However, some vehicles may not be able to accommodate a physical printed proof of purchase (e.g., motorcycles, convertible, etc.).

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 illustrates a block diagram of an example parking management system, in accordance with various embodiments;

FIG. 2 illustrates a block diagram of an example parking management system, in accordance with alternate embodiments;

FIG. 3 illustrates a block diagram of an example parking management system, in accordance with alternate embodiments;

FIG. 4 illustrates a smart parking system, in accordance with various embodiments;

FIG. 5 illustrates an operational flow for a PM server, arranged in accordance with at least some embodiments described herein;

FIG. 6 illustrates an example computer program product 600, arranged in accordance with at least some embodiments described herein;

FIG. 7 illustrates an operational flow for a client device, arranged in accordance with at least some embodiments described herein;

FIG. 8 illustrates an example computer program product 800, arranged in accordance with at least some embodiments described herein; and

FIG. 9 is a block diagram illustrating an example computing device 900, such as might be embodied by a person skilled in the art, which is arranged in accordance with at least some embodiments of the present disclosure.

### DETAILED DESCRIPTION

The following description sets forth various examples along with specific details to provide a thorough understanding of claimed subject matter. It will be understood by those skilled in the art, however, that claimed subject matter may be practiced without some or more of the specific details disclosed herein. Further, in some circumstances, well-known methods, procedures, systems, components and/or circuits have not been described in detail in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, apparatus, and systems related to intelligent parking management.

In some urban areas, parking a vehicle may be difficult. In order to help facilitate management of limited parking spaces, various methods may be employed. In one example, parking spaces may be managed by a metered system such as, but not limited to, parking meters. The parking meters may include the use of a proof of payment (“ticket slip”), which may be a physical paper to be placed inside a vehicle viewable by a parking enforcement official. The ticket slips may not be compatible with some vehicles because some vehicles may be an open type vehicle such as, but not limited to, an open cabin vehicle (e.g., convertible), a motorcycle, etc. Additionally, since people and devices may be connected in a variety of manners, conventional management of vehicle parking spaces may be facilitated in a more sophisticated manner.

Before describing in further detail the various embodiments disclosed herein, a non-limiting example scenario utilizing at least some various embodiments may be described in order to facilitate a more thorough understanding of the claimed subject matter. In one non-limiting scenario, a person may want to find a parking space close to a shopping mall in a busy downtown area. The shopping mall may be particularly busy during certain time periods (e.g., 12:00 p.m. to 3:00 p.m. on Saturday afternoon). The person may want to find a parking space close to the shopping mall at or near 2:30 p.m. The person may transmit a request to a vehicle management server via a client device (e.g., a mobile phone). The request may include information regarding the parking space (e.g., information regarding location of the shopping mall and/or desired time). The parking management server may access a database for parking spaces in proximity to the shopping mall. The parking management server may determine the closest available parking space to the shopping mall around the time desired. Once the available parking space is determined, the parking management server may transmit to the user a geographic location of the available parking space and the times available. The user may transmit a confirmation of selection of the available parking space to the parking management server. The transmitted confirmation may include payment information such as, but not limited to, credit card information.

In another non-limiting scenario, a user may be driving to a downtown area, and the user may request a parking space close to a particular destination in the downtown area. A parking management server may receive the request. As alluded to previously, the request may include information such as, but not limited to, a geographic location of the user (e.g., the vehicle) including an estimated time of arrival at the particular destination. The parking management server may access a database to determine an available parking space in the vicinity of the particular destination at approximately the time of arrival at the particular destination. Once the available parking space is determined, the parking management server may transmit a geographic location of the available parking space and a time duration of availability of the parking space (e.g., the available parking space may be held for a predetermined period of time). This and other sophisticated parking management methods, systems, and apparatus, will be disclosed.

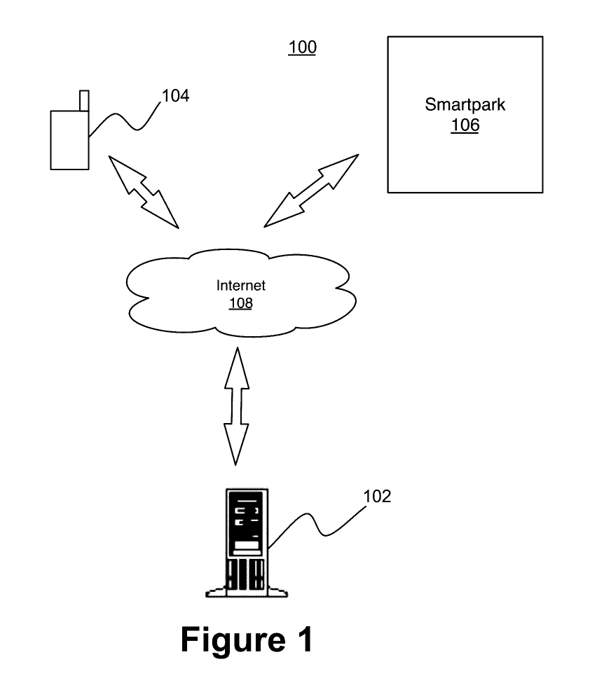

Turning now to FIG. 1 (FIG. 1), where FIG. 1 illustrates a block diagram of an example parking management system, in accordance with various embodiments. In FIG. 1, parking management system (hereon out, PMS) 100 may include a parking management server (hereon out, PM server) 102, a client device 104, and a smart parking space (hereon out, SPS) 106. The client device 104, the PM server 102, and the SPS 106 may be communicatively coupled to each other via the Internet 108. Shown in FIG. 1, the PM server 102 may receive a request for a parking space from the client device 104. Based, at least in part, on the received request, the PM server 102 may determine an available SPS 106. The PM server 102 may transmit the identification of the available SPS 106 to the client device 104.

In one example, the request may include a geographic location of the client device 104. In another example, the request may include a location of a preferred SPS 106. Other data that may be included in the request may comprise information about the user's taste preferences, user profile information user subscriber information, user vehicle information, user destination information, duration of parking request, user historical parking data, user payment information, user contact information, or the like or combinations thereof. In an example, a user's taste preferences may pertain to a user's preferences or identified need for products, music, and/or services. User profile information may include information about the user's age, gender and other identifying characteristics as well as payment information, socioeconomic information, vehicle information, familial status, number and age of children, health status, and the like or combinations thereof. User subscriber information may include information about whether the user is a subscriber to a particular parking payment program, the user's eligibility for discounts on parking, information about whether the user can purchase parking spaces for other patrons and/or whether the user is eligible for parking discounts. User vehicle information may include vehicle identification number, year, make and model of vehicle, maintenance schedule vehicle and or the like or a combination thereof. User destination information may include information such as where the user is traveling to, traveling from, whether they are on their way to work or home and the like or combination thereof. Information about the duration of the parking request may be identified in the request as well. User historical parking information may include information about the user's parking habits, whether the user owes money on parking tickets, whether the user has a tendency to get parking tickets, where user tends to need multiple parking spaces in a single trip and the like or combinations thereof. User payment information may include credit card banking another payment information. User contact information may include information on how to get hold of the user and or emergency contact information.

In one example, the PM server 102 may determine the available SPS 106 based, at least in part, on a geographic location of the client device 104. In another example, the PM server 102 may determine the available SPS 106 based, at least in part, on an estimated time of arrival of the client device 104 at the available smart parking space 106. In yet another example, the PM server 102 may determine the available SPS 106 based, at least in part, on close proximity to the geographic location of the client device 104. In another example, PM server 102 may suggest one or more SPS 106. PM server 102 may suggest SPS 106 based at least in part on any information available in the request (examples of the various types of information available on the request were discussed above). Thus, for example, PM server 102 may suggest SPS 106 in close proximity to vendors selling products, music and or services identified in user preferences information in the request.

In one example, the PM server 102 may transmit the identification of the available SPS 106 to the client device 104, where the availability may include a time range when the available SPS 106 is available. In an example, parking server 102 may have stored in memory parking data identifying a geographical location of one or more parking spaces in a particular geographical area. The parking data may include identification of whether the one or more parking spaces are currently in use by a vehicle, reserved for use, a time when the one or more parking spaces may be available, parking rates, whether validation is available, which vendors validate, advertising associated with a location of the one or more parking spaces, incentives associated with the one or more parking spaces, and/or the like or a combination thereof. Parking data may be communicated to client device 104 with an SPS 106 suggestion.

In another example, client device 104 may comprise a parking enforcement device. In this scenario, PM server 102 is configured to communicate parking enforcement data to client device 104. Client device 104 may send and receive information about enforcement of authorized use of parking spaces within the PMS 100. Such information may include information identifying vehicles in smart parking spaces 106, identifying users associated with vehicles in SPS 106, information relating to whether SPS 106 is occupied, information relating to whether SPS 106 is occupied by an authorized user, information relating to whether SPS 106 is occupied by a vehicle that is over the boundaries of SPS 106 and the like or any combinations thereof.

In another example, enforcement functions of PM server 102 can include automatic generation tickets for unauthorized use of SPS 106. Such tickets may be sent to a violator's client device 104 via PM server 102 through PMS 100. Enforcement functions of PMS 100 may include identification of vehicles associated with users that are not part of a parking management subscriber network, for example, sensors in SPS 106 may identify vehicle that is over time or otherwise occupying SPS 106 in an unauthorized manner. Unauthorized vehicles identified by PMS 100 may be connected to an owner via Department of Motor Vehicles records or some other resource. In this instance owners of the unauthorized vehicles occupying SPS 106 may be sent tickets through the mail. In another example enforcement functions of PM server 102 may identify a missing or stolen vehicle should the vehicle be found to occupy a SPS 106. Identified vehicles may be reported to the proper authorities via PM server 102 and/or client device 104, for example.

The enforcement system may include automatically identifying (via subscriber and/or user information, information garnered from license plate information, or the like or combinations thereof), citing and ticketing identified violators, automatically sending tickets to the violators via email, text message, or other electronic communication method wherein the email, text, or other electronic communication permits an automatic method of payment for violations, for example, by response to the text message, email, etc.

An unauthorized vehicle can be identified via subscriber identification through sensor recognition of a wireless tag or other wireless transmitting device or identifying the user's mobile device. If the vehicle does not belong to a subscriber the vehicle can be identified by use of a camera, taking picture of license plates. A ticket for a parking violation may also be sent to the home of the identified licensed vehicle owner.

The enforcement system may partner with DMVs to track or monitor registered vehicles for registration violations, expired licensing, unpaid parking tickets, tracking vehicles for law enforcement purposes and amber alert.

In FIG. 1, the client device 104 may be a wide range of client devices such as, but not limited to, mobile phones, computing devices integrated with a vehicle, tablet devices, smartphones, smart watch, wearable computing devices, etc., and accordingly, the claimed subject matter is not limited in these respects. The SPS 106 may include various electronic devices to help facilitate parking space determination such as, but not limited to, parking areas having sensors to help facilitate determination of presence of a vehicle, identification of the vehicle, identification of vehicle type, and the like or any combinations thereof. SPS 106 may include parking meters having wireless and/or wireline communication capabilities for communicating and/or determining a presence or other information about a vehicle in a parking space, and so forth.

In an example, once PM server 102 has transmitted identification of the one or more available SPS 106 to client device 104, client device 104 may respond with an acknowledgment identifying which of the available smart park 106 spaces to reserve, this may be based on a user input and/or maybe automated. Client device 104 may reserve the selected smart park 106 for any vehicle. In an example, a default may be that smart park 106 will be reserved for the vehicle associated with the user device. However, the client device 104 may identify a different vehicle for which Smart Park 106 is to be reserved. The vehicle identification may be as simple as providing a name and/or a license plate number or other vehicle identifier. Other methods of identifying the vehicle may be used and claimed subject matter is not limited in this regard. For example, a different user/subscriber may be identified in the acknowledgment that is linked to a different particular vehicle. This may be done in connection with a subscriber program wherein members are linked to vehicles and where subscribers receive parking benefits such as identification and reservation of available parking spaces, discounted parking spaces, vendor coupons based on location of the reserved parking spaces and the like, or any combinations thereof.

In another example, PM server 102 may communicate directly with autonomous vehicles regarding parking information and suggested SPS 106. Autonomous vehicles may be programmed to receive parking information from PM server 102 and may respond, for example, by autonomously navigating to the suggested SPS 106. SPS 106 may be suggested based on a variety of factors such as time running out on current space, location of user associated with autonomous car, an emergency need to evacuate vehicles from a particular area, and the like or any combinations thereof. If the autonomous vehicle relocates to a new SPS 106 based on instructions from PM server 102 autonomous vehicle and/or PM server 102 may send a message to client device 104 identifying the new SPS 106 where the autonomous vehicle moved based on PM server 102 instructions.

The PM server 102 may be of a wide range of computing devices that may be configured to facilitate parking management as will be described in further detail. Additionally, even though PM server 102 may be shown as a single device, it should be appreciated that it is contemplated within the scope of the claimed subject matter that the PM server 102 may include cloud computing type services such as, but not limited to, ubiquitous computing, and accordingly, the claimed subject matter is not limited in these respects.

In an example, client device 104 may download a software application. In an example, detection of a SPS 106 by software on CD 104 may trigger the software application to open and become accessible to a user. In an example, credentials for an authentication process may be stored and may automatically populate an authentication window and/or other graphical user interface. Authentication may involve any authenticating by any processes known in the art including dual authentication requiring a sensor communication and an authentication via a user device.

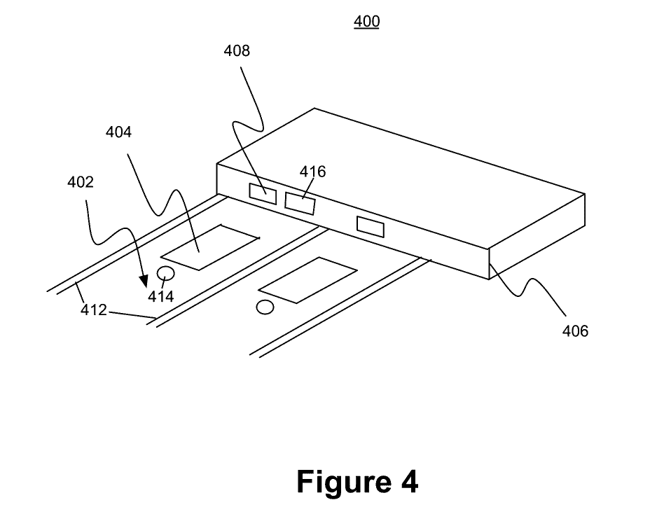

In an example, detection of SPS 106 may be via receipt of a signal from beacon 414 (see FIG. 4), recognition by the software application that smart parking space 106 is proximate client device 104 may be based on GPS data, and/or user may manually indicate a present location of smart parking space 106. In an example, the software application may calculate a distance to known smart parking space 106. Warning timing may be set and predetermined as to reminders of when parking meter will expire. The system and apparatus described herein may use dedicated processor systems, micro controllers, programmable logic devices, microprocessors, or the like, or any combination thereof, to perform some or all of the operations described herein. Some of the operations described above may be implemented in software and other operations may be implemented in hardware.

In an example, the software may generate a graphical user interface (GUI) on client device 104. The GUI may be opened manually and/or automatically activated upon detection of SPS 106. The GUI may show user options for user to pay automatically, select time and parking space, reserve parking space. GUI may show various coupons available as incentives to select particular parking spaces. For example, if user choose parking space A near vendor B then coupon X will be provided. Coupons or other incentives may be provided as QR code, UPC code, downloadable UID number etc. In this way, parking management and advertising associated with parking management may all be communicated via electronic devices and therefore be paperless.

Payment may be facilitated by PMS 100. In an example, there are several ways that a user may pay for parking space using PMS 100. For example, when a user arrives at SPS 106, client device 104 may detect a proximity of SPS 106 and may launch a user interface screen showing payment options. Payment options may include payment through parking server 102 (via a server portal/website) wherein a user's account may be accessed to make payment for the use of SPS106. The user may have funds already in the user account to pay for parking. Another example, a user may be given payment options such as a payment using PayPal, credit cards, direct deposit from a bank account via ACH, or the like, or a combination thereof.

In an example, when a user approaches SPS 106, detection of SPS 106 may be executed by a variety of methods. In one example, detection may occur via RFID tagging wherein a user's vehicle or mobile device may be equipped with an RFID tag and SPS 106 may comprise an RFID tag reader. In another example, SPS 106 may be prepaid by another user. To verify and/or acknowledge payment for a particular period of time to user client device 104 may launch a payment screen or payment acknowledgment screen as user approaches SPS 106 identifying the prepayment. The prepayment may be acknowledged by other methods, for example, user may receive an email with a verification identifying the prepayment. Verification may include a confirmation number. In another example, prepayment may be identified through server 102.

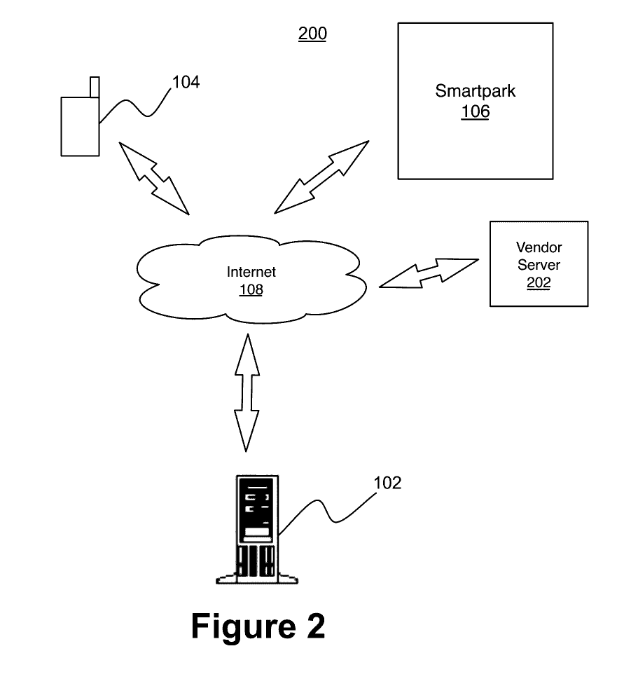

FIG. 2 illustrates a block diagram of an example parking management system (PMS), in accordance with alternate embodiments. In FIG. 2, a PMS 200 may include the PM server 102, the client device 104, and the SPS 106 (all shown in FIG. 1). Additionally, in FIG. 2, the PMS 200 may include a vendor server 202. One or more vendors may be connected through vendor server 202 to PMS 200 to coordinate advertising (e.g., sending users and/or system subscribers coupons) based on request information, location of a suggested SPS 106 and/or current location.

The PM server 102, the client device 104, the SPS 106, and the vendor server 202 may all be communicatively coupled via the Internet 108. In one example, the PM server 102 may receive a request for a parking space from the client device 104. Based, at least in part, on the received request, the PM server 102 may determine available SPS 106 as previously described. In FIG. 2, the PM server 102 may identify and suggest an available SPS 106 in proximity to a vendor based on information received in the request or derived from other sources. Information in the request may indicate that the user associated with client device 104 is in the market for a pair of shoes. This information may be in the user preference data sent in the request. Alternatively, this information may be garnered from other sources such as an online profile of the user associated with the client device 104 and/or linked to PMS 200. The vendor may be, but is not limited to, a shoe store. The PM server 102 may transmit a coupon for the vendor (e.g., discount coupon on shoes for the particular vendor) along with the identification of the available SPS 106. The PM server 102 may communicate with the vendor server 202 to receive the coupon to be transmitted to the client device.

In one example, the coupon may include an expiration time to encourage and facilitate use of the coupon while shopping at the vendor. In another example, the expiration time of the coupon may be based, at least in part, on the parking time limit associated with the identified smart parking space 106 suggested to client device 104. In yet another example, the coupon may be based, at least in part, on a geographic location of the available SPS 106. In a further example, the coupon may be provided based, at least in part, on an identity of the user (e.g., subscription to a parking management system), where the user may be identified as shopping for shoes at a particular vendor including particular times and dates (i.e., intelligent vendor interaction). Vendors may offer validation or parking fee reimbursement in exchange for purchasing vendors goods or services. The validation offer may be sent with a notice to client device 104 identifying open SPS 106. Parking validation may be paid for pro-rata by a plurality of vendors based on a total of purchases associated with a user's use of an identified SPS 106 (e.g., coupons redeemed in several stores proximate an SPS 106 where a user parked and redeemed within a time limit set in the coupon). Such co-operation among vendors may be coordinated via vendor server 202 or PM server 102.

Advertising campaigns may be run via vendor server 202. For example, vendor can set up campaign from own server or vendor can work with parking management server 102 administrator to set-up advertising campaigns. In an example, a vendor may set up a campaign for advertising with smart parking management system 200. Vendors may use their own server that may send and/or receive data regarding the advertising campaign to server 102 which may simply pass advertising onto users according to commands from the vendor's server. Vendors may be subscribers to parking management system 200. An advertising campaign may run by a vendor may comprise vendor providing incentives to drivers who are potential users of SPS 106. Such incentives may include coupons, in-store discounts, prizes, advertisements, parking validation and etc. or any combinations thereof. Incentives may be time limited to encourage use during parking time limit. A vendor may be able to work with server 102 to setup one or more adverting campaign(s). Vendors may have special administrative rights on server 102 in order to administer ad campaigns. Server 102 may be configured to provide location based advertising services based on server 102's collection of data regarding SPS 106 and/or other spaces like SPS 106 as well as other data identifying a location(s) of one or more users accessing smart parking system 100. In an example, vendor servers may be able to access location based advertising functions of server 102. Additionally, because users of parking management system 100 may be identifying their whereabouts to the system and/or providing other types of personal information, vendors may be able to target particular users based on their location and/or personal characteristics to entice users to park closer to vendor's brick and mortar locations. By passively (recording users actions, tracking parking habits etc.) or actively gathering supplemental data (such as requesting personal information) vendor system and/or smart parking management system 200 may more accurately and effectively use location based advertising to target ads.

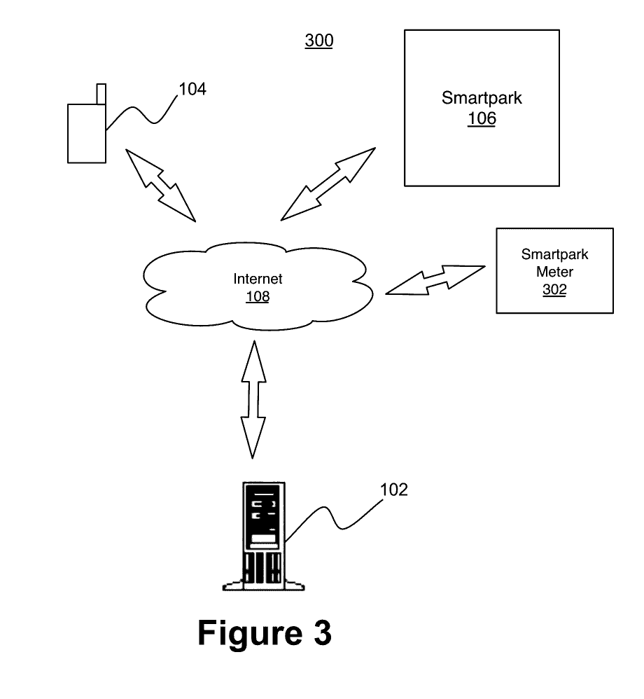

FIG. 3 illustrates a block diagram of an example parking management system, in accordance with alternate embodiments. In FIG. 3, a PMS 300 may include the PM server 102, the client device 104, and the SPS 106. Additionally, in FIG. 3, the PMS 300 may include a smarkpark meter 302. The PM server 102, the client device 104, the SPS 106, and the SPS meter 302 may all be communicatively coupled via the Internet 108. In one example, the PM server 102 may receive a request for a parking space from the client device 104. Based, at least in part, on the received request, the PM server 102 may determine an available SPS 106 as previously described. However, in FIG. 3, the PM server 102 may determine that the available SPS 106 communicates with the SPS meter 302. The SPS meter 302 may receive indications of a presence of a vehicle and/or occupancy of a parking space. For example, the SPS meter 302 may receive an indication that a particular space is available and/or available at a predetermined time (e.g., expiration of the meter for a particular space) and transmit the information regarding the parking space to the PM server 102. The PM server 102 may transmit the identification of the available SPS 106 to the client device 104.

In one example, the SPS meter 302 may include a beacon to facilitate indication of an available parking space. The SPS meter 302 may receive an estimated time of arrival of the user (i.e., client device 104) from the PM server 102 based, at least in part, on the geographic location of the client device, which may be periodically updated utilizing a global positioning system (GPS). The GPS system may be utilized by any and/or all of the components described. For example, the client device 104 and/or the PM server 104 may be configured to utilize a GPS system and/or signal to help facilitate determination of various geographic locations, and accordingly, the claimed subject matter is not limited in these respects.

It should be appreciated that it is contemplated within the scope of the claimed subject matter that a wide range of communicative methodologies may be employed with respect to the PMSs 100, 200, and 300 described. For example, the communicative methodologies may include communicative methodologies such as, but not limited to, wired, wireless including long range or short range (e.g., Dedicated Short Range Communications, ZigBee, Personal Area Networks, Bluetooth, Ultra-wideband, Wireless Local Area Network, IEEE 802.11 branded including WiFi and HiperLan, Wireless Metropolitan Area Network) and any combination thereof. Accordingly, the claimed subject matter is not limited in these respects.

FIG. 4 illustrates example set of smart parking spaces 400, in accordance with various embodiments. In FIG. 4, smart parking space (SPS) 402 bounded by lines 412 includes a sensor 404. The sensor 404 may be provided as a sensor 404 included in the SPS 402. The sensor 404 may be configured to receive an indication of the presence of a vehicle or any other object that may trigger the sensor 404 such as, but not limited to, an automobile, a motorcycle, a scooter, a bicycle, etc. Sensor 404 may also detect the presence of client device 104 which may indicate the presence of a vehicle in SPS 402.

In FIG. 4, an indication of presence of a vehicle in the SPS 402 via the sensor 404 may be provided to a PM server such as, but not limited to, those previously described. Alternatively and/or in addition to, an indication of a vehicle in the parking space 402 may be provided to a SPS meter such as, but not limited to, those previously described. Sensor 404 may be configured to detect presence of a vehicle, client device 104, a handicapped authorization tag, a license plate number etc. Sensor 404 may communicate with PM server 102 and/or parking meter 302.

Additionally, shown in FIG. 4, the set of SPS 400 may include a curb 406. The curb 406 may include a proximity sensor 408. The proximity sensor 408 may be configured to receive an indication of the presence of a vehicle or any other object that may be detected by the proximity sensor 408 such as, but not limited to, an automobile, a motorcycle, a scooter, a bicycle, etc. In FIG. 4, an indication of presence of a vehicle in the parking space 402 via the proximity sensor 408 may be provided to a PM server such as, but not limited to, those previously described. Alternatively and/or in addition to, an indication of a vehicle in the parking space 402 may be provided to a SPS meter such as, but not limited to, those previously described.

Additionally, information regarding the presence of a vehicle in a parking space may help facilitate parking enforcement. For example, parking enforcement may be facilitated by information provided by the set of SPS 400 regarding a vehicle occupying the parking space 402 beyond an allotted time (e.g., overstayed the meter), a vehicle parked beyond the bounds 412 of the parking space 402 (e.g., incorrectly parked in the parking space 402), a violation of a disability reserved parking space, and so forth.

It should be appreciated that the set of SPS 400 in FIG. 4 may include other components such as, but not limited to, a SPS meter 302 (shown in FIG. 3). For example, a vehicle may include various communicative capabilities including sensors. The sensors may facilitate indication of occupying SPS 402, where the indication may be communicatively transmitted to a SPS meter 302 in proximity to SPS 402, thereby providing an indication of whether the parking space 402 is occupied and/or including by a particular vehicle and/or client device (e.g., user).

Shown in FIG. 4, the sensor 404 may be a wide variety of sensors such as, but not limited to, a pressure type sensor, a piezoelectric type sensor, optical pressure type sensor, etc., and accordingly, the claimed subject matter is not limited in these respects. The proximity sensor 408 included in the curb 406 may be a wide variety of proximity sensors such as, but not limited to, an infrared type proximity sensor, a laser type proximity sensor, a radar type proximity sensor, optical type proximity sensor, etc., and accordingly, the claimed subject matter is not limited in these respects.

In an example, sensor 404 may be configured to communicate sensor data directly to parking server 102 (see FIG. 1) and/or may be configured to communicate sensor data to a parking meter 302 for further communicating to PM server 102. Sensor data may indicate a status of SPS 402 to parking server 102 and/or parking meter 302. The status may indicate whether SPS 402 is currently in use by a vehicle, a proximity of vehicle to SPS 402 borders such as one or more of lines 412, whether smart parking space 402 is reserved and/or out of commission for example due to road construction or other event preventing use of SPS 402.

In an example, a vehicle and/or client device 104 may detect SPS 402 by a variety of methods. For example, SPS 402 may include a beacon 414 configured to send out a wireless signal. The wireless signal may be long or short range wireless signal including, for example, DSRC (Dedicated Short Range Communications), ZigBee, Personal area networks, Bluetooth, Ultra-wideband (UWB), Wireless LAN (WLAN), (IEEE 802.11 branded as Wi-Fi and HiperLAN), Wireless Metropolitan Area Networks (WMAN), LMDS, WiMAX, and HiperMAN), any new signal designed specifically for this purpose or any new wireless interface in general that may come into existence in the future and/or the like or a combination thereof. The beacon 414 may be incorporated with sensor 404 and may form a portion of a system configured to send and/or receive wireless signals to and/or from parking meter 302, parking server 102, vehicle and/or client device 104. In an example, a proximity to SPS 402 may be detected by client device 104 and/or vehicle via a GPS signal.

In an example, SPS 402 may include an electronic display 416 having incorporated therein such devices as are necessary to display graphics and/or text on display 416. Display 416 may be coupled to a transmitter and/or receiver and maybe configured to send and receive data from parking meter 302 and/or parking server 102. Display 416 may display a warning such as a colored light if sensor 404 detects that the vehicle is on and/or outside one or more lines 412. Responsive to signals or other communication from PM server 102, display 416 may be configured to indicate whether a parking space is reserved by for example presenting the word “RESERVED” in text on the display and/or showing a colored display for example red for reserved and green for available. Display 416 may be constructed of materials capable of withstanding impact from cars and/or attempts to vandalize. Such materials may include thick plexiglass.

Any or all portions of parking management systems 100, 200, or 300, or 400 may be powered by solar power, batteries of various types, other alternative forms of energy and/or conventional power supplies.

Mapping of smart parking spaces 402 may be accomplished in a variety of ways. In an example, SPS 402 may be mapped via global positioning satellite (GPS), manually, and/or according to data provided back to server 102 by users. In an example, client's devices 104 and/or a navigation device or other devices in a vehicle may send and/or receive data associated with SPS 402 when in proximity of SPS 402. For example, client device 104, the vehicle and/or any onboard devices may communicate with parking meter 302 associated with SPS 402 and/or may detect sensor data. Such data associated with SPS 402 may be used to build a map of available parking spaces. Data received from sensors may identify a location of SPS 402, whether SPS 402 is open, whether SPS 402 is reserved, etc. or any combinations thereof.

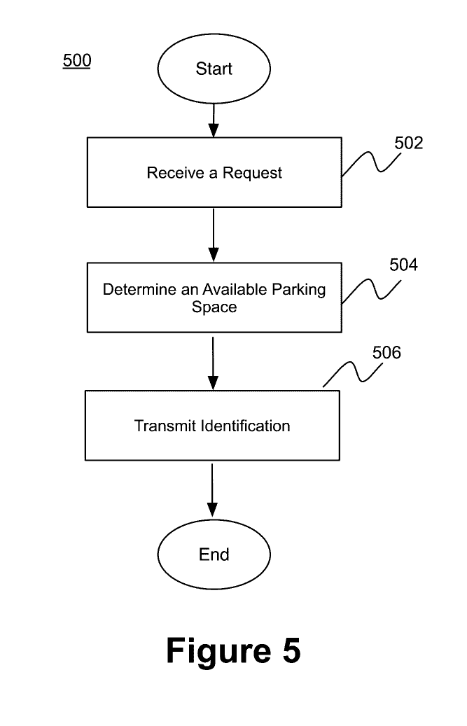

FIG. 5 illustrates an operational flow for a PM server, arranged in accordance with at least some embodiments described herein. In some portions of the description, illustrative implementations of the method are described with reference to the elements of the components described with respect to FIGS. 1-4. However, the described embodiments are not limited to these depictions. More specifically, some elements depicted in FIGS. 1-4 may be omitted from some implementations of the methods details herein. Furthermore, other elements not depicted in FIGS. 1-4 may be used to implement example methods detailed herein.

Additionally, FIG. 5 employs block diagrams to illustrate the example methods detailed therein. These block diagrams may set out various functional block or actions that may be described as processing steps, functional operations, events and/or acts, etc., and may be performed by hardware, software, and/or firmware. Numerous alternatives to the functional blocks detailed may be practiced in various implementations. For example, intervening actions not shown in the figures and/or additional actions not shown in the figures may be employed and/or some of the actions shown in one figure may be operated using techniques discussed with respect to another figure. Additionally, in some examples, the actions shown in these figures may be operated using parallel processing techniques. The above described, and other not described, rearrangements, substitutions, changes, modifications, etc., may be made without departing from the scope of the claimed subject matter.

In some examples, operational flow 500 may be employed as part of a PM server, as previously described.

Beginning at block 502 (“Receive a Request”), the PM server 102 may receive a request for a parking space from the client device 104. The request may include various information such as, but not limited to, a geographic location of the client device, a geographic location of the desired parking space, time range for the desired parking space, etc. As previously described, the request may be received via a wide range of communicative methodologies and may include a wide range of information. Additionally, the client device 104 may include any number of devices such as, but not limited to, smartphones, smart vehicles, etc.

Continuing from block 502 to 504 (“Determine an Available Parking Space”), the PM server 102 may determine an available parking space based, at least in part, on the received request from the client device 104. As previously described, the determination may be based, at least in part, on a wide variety of information such as information related to subscription of the user to a parking management service as described, geographic location, information from a SPS meter, and/or information from a SPS, and/or any combination thereof.

Once an identification of an available parking space is determined, the PM server 102 may transmit the identification to the client device at block 506 (“Transmit Identification”).

As previously alluded to, in one example, the PM server 102 may receive a confirmation of selection of the available parking space from the client device 104. It is contemplated within the scope of the claimed subject matter that the confirmation may include a wide variety of information such as, but not limited to, payment information (e.g., credit card), a user's subscription information, an estimated time of arrival of the user (e.g., the client device), etc.

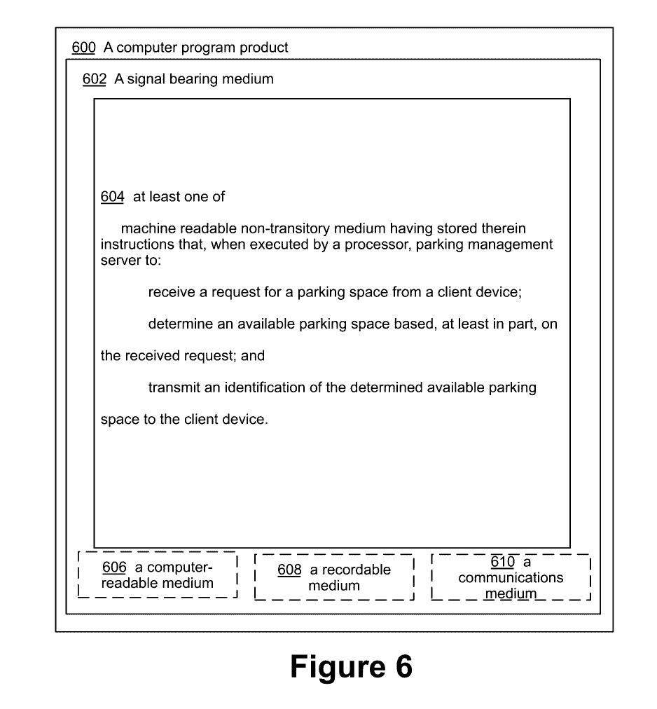

In general, the operational flow described with respect to FIG. 5 and elsewhere herein may be implemented as a computer program product, executable on any suitable computing system, or the like. For example, a computer program product for facilitating smart parking management. Example computer program products may be described with respect to FIG. 6 and elsewhere herein.

FIG. 6 illustrates an example computer program product 600, arranged in accordance with at least some embodiments described herein. Computer program product 600 may include machine readable non-transitory medium having stored therein instructions that, when executed, cause the machine to intelligently manage parking spaces, according to the processes and methods discussed herein. Computer program product 600 may include a signal bearing medium 602. Signal bearing medium 602 may include one or more machine-readable instructions 604, which, when executed by one or more processors, may operatively enable a computing device to provide the functionality described herein. In various examples, the devices discussed herein may use some or all of the machine-readable instructions.

In some examples, the machine readable instructions 604 may include instructions that, when executed, cause the machine to, receive, at a parking management server, a request for a parking space from a client device, determine an available parking space based, at least in part, on the received request, and transmit an identification of the determined available parking space to the client device.

In some implementations, signal bearing medium 602 may encompass a computer-readable medium 606, such as, but not limited to, a hard disk drive, a Compact Disc (CD), a Digital Versatile Disk (DVD), a digital tape, memory, etc. In some implementations, the signal bearing medium 602 may encompass a recordable medium 608 such as, but not limited to, memory, read/write (R/W) CDs, R/W DVDs, etc. In some implementations, the signal bearing medium 602 may encompass a communications medium 610 such as, but not limited to, a digital and/or an analog communication medium (e.g., a fiber optic cable, a waveguide, a wired communication link, a wireless communication link, etc.). In some examples, the signal bearing medium 602 may encompass a machine readable non-transitory medium.

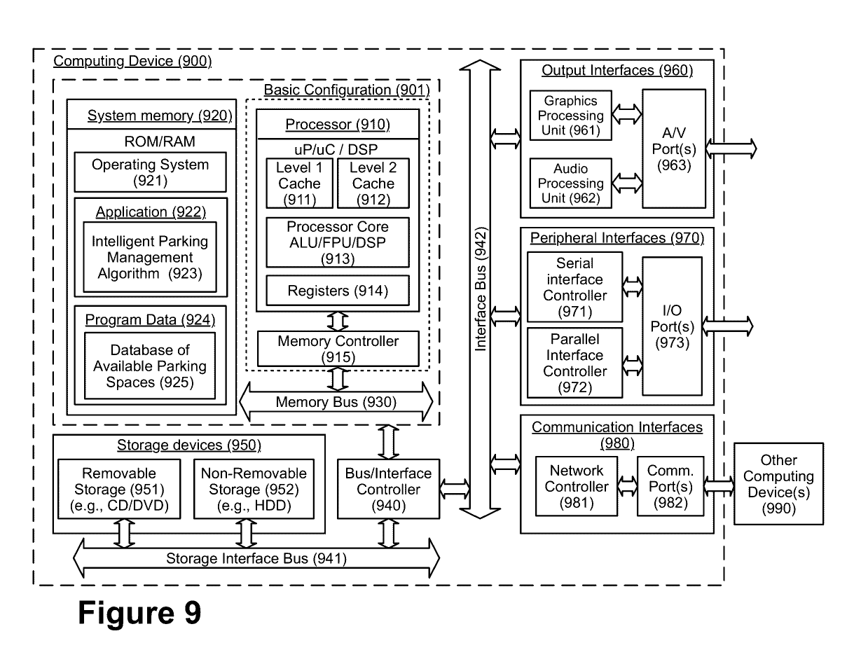

In general, the methods described with respect to FIG. 6 and elsewhere herein may be implemented in any suitable computing system. Example systems may be described with respect to FIG. 9 and elsewhere herein. In general, the system may be configured to facilitate utilization of a smart parking system, in accordance with various embodiments.

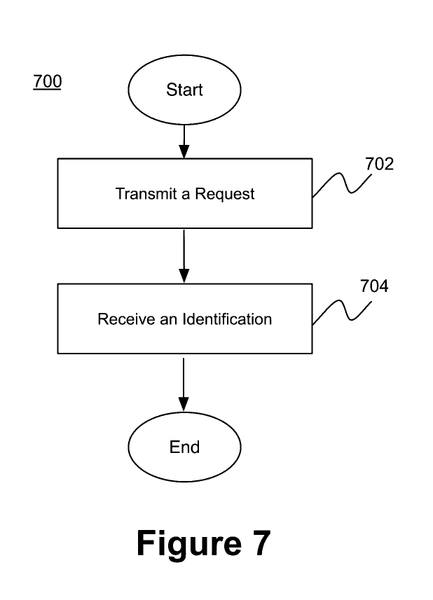

FIG. 7 illustrates an operational flow for a client device, arranged in accordance with at least some embodiments described herein. In some portions of the description, illustrative implementations of the method are described with reference to the elements of the components described with respect to FIGS. 1-4. However, the described embodiments are not limited to these depictions. More specifically, some elements depicted in FIGS. 1-4 may be omitted from some implementations of the methods details herein. Furthermore, other elements not depicted in FIGS. 1-4 may be used to implement example methods detailed herein.

Additionally, FIG. 7 employs block diagrams to illustrate the example methods detailed therein. These block diagrams may set out various functional block or actions that may be described as processing steps, functional operations, events and/or acts, etc., and may be performed by hardware, software, and/or firmware. Numerous alternatives to the functional blocks detailed may be practiced in various implementations. For example, intervening actions not shown in the figures and/or additional actions not shown in the figures may be employed and/or some of the actions shown in one figure may be operated using techniques discussed with respect to another figure. Additionally, in some examples, the actions shown in these figures may be operated using parallel processing techniques. The above described, and other not described, rearrangements, substitutions, changes, modifications, etc., may be made without departing from the scope of the claimed subject matter.

In some examples, operational flow 700 may be employed as part of a client device, as previously described.

Beginning at block 702 (“Transmit a Request”), the client device 104 may transmit a request for a parking space to the PM server 102. The request may include various information such as, but not limited to, a geographic location of the client device, a geographic location of the desired parking space, time range for the desired parking space, etc. As previously described, the request may be transmitted via a wide range of communicative methodologies and may include a wide range of information. Additionally, the client device 104 may include any number of devices such as, but not limited to, smartphones, smart vehicles, etc.

Continuing from block 702 to 704 (“Receive an Identification”), the client device 104 may receive an identification of an available parking space from the PM server 102. As previously described, the determination may be based, at least in part, on a wide variety of information such as information related to subscription of the user to a parking management service as described, geographic location, information from a SPS meter, and/or information from a SPS, and/or any combination thereof.

In one example, the client device 102 may be configured to transmit a confirmation to the PM server 102. As previously described, in one example, the client device 104 may transmit a confirmation having a wide variety of information such as, but not limited to, payment information (e.g., credit card), a user's subscription information, an estimated time of arrival the client device 104, etc.

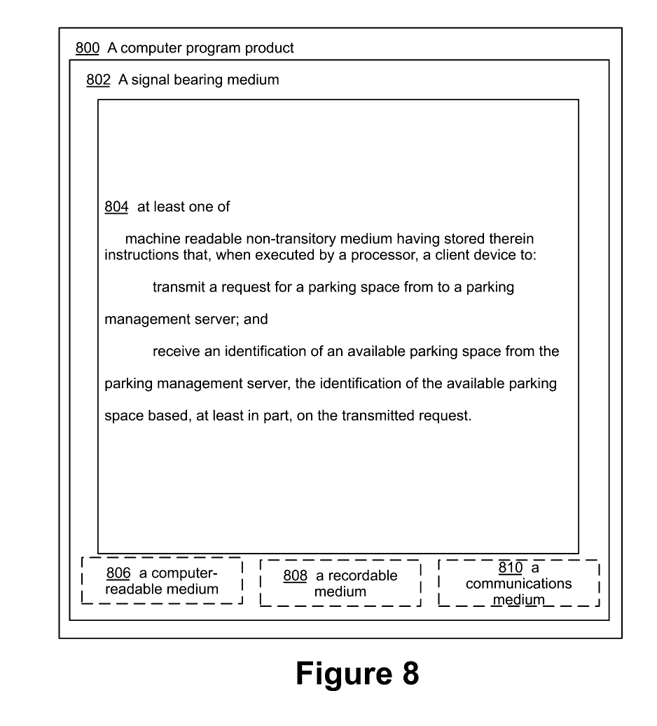

In general, the operational flow described with respect to FIG. 7 and elsewhere herein may be implemented as a computer program product, executable on any suitable computing system, or the like. For example, a computer program product for facilitating smart parking management. Example computer program products may be described with respect to FIG. 8 and elsewhere herein.

FIG. 8 illustrates an example computer program product 800, arranged in accordance with at least some embodiments described herein. Computer program product 800 may include machine readable non-transitory medium having stored therein instructions that, when executed, cause the machine to intelligently request parking spaces, according to the processes and methods discussed herein. Computer program product 800 may include a signal bearing medium 802. Signal bearing medium 602 may include one or more machine-readable instructions 804, which, when executed by one or more processors, may operatively enable a computing device to provide the functionality described herein. In various examples, the devices discussed herein may use some or all of the machine-readable instructions.

In some examples, the machine readable instructions 804 may include instructions that, when executed, cause the machine to, at a client device, transmit a request for a parking space to a parking management server, and receive an identification of an available parking space from the parking management server, the identification of the available parking space based, at least in part, on the transmitted request. The identification may include a wide variety of information such as, but not limited to, a geographic location of the available parking space, estimated time of arrival at the parking space, coupon from vendors, etc.

In some implementations, signal bearing medium 802 may encompass a computer-readable medium 806, such as, but not limited to, a hard disk drive, a Compact Disc (CD), a Digital Versatile Disk (DVD), a digital tape, memory, etc. In some implementations, the signal bearing medium 802 may encompass a recordable medium 808 such as, but not limited to, memory, read/write (R/W) CDs, R/W DVDs, etc. In some implementations, the signal bearing medium 802 may encompass a communications medium 810 such as, but not limited to, a digital and/or an analog communication medium (e.g., a fiber optic cable, a waveguide, a wired communication link, a wireless communication link, etc.). In some examples, the signal bearing medium 802 may encompass a machine readable non-transitory medium.

In general, the methods described with respect to FIG. 8 and elsewhere herein may be implemented in any suitable computing system. Example systems may be described with respect to FIG. 9 and elsewhere herein. In general, the system may be configured to facilitate utilization of a smart parking module, in accordance with various embodiments.

FIG. 9 is a block diagram illustrating an example computing device 900, such as might be embodied by a person skilled in the art, which is arranged in accordance with at least some embodiments of the present disclosure. In one example configuration 901, computing device 900 may include one or more processors 910 and system memory 920. A memory bus 930 may be used for communicating between the processor 910 and the system memory 920.

Depending on the desired configuration, processor 910 may be of any type including but not limited to a microprocessor (μP), a microcontroller (μC), a digital signal processor (DSP), or any combination thereof. Processor 910 may include one or more levels of caching, such as a level one cache 911 and a level two cache 912, a processor core 913, and registers 914. The processor core 913 may include an arithmetic logic unit (ALU), a floating point unit (FPU), a digital signal processing core (DSP Core), or any combination thereof. A memory controller 915 may also be used with the processor 910, or in some implementations the memory controller 915 may be an internal part of the processor 910. It should be appreciated that parking management systems described herein may be configured to communicatively couple with the example computing device 900.

Depending on the desired configuration, the system memory 920 may be of any type including but not limited to volatile memory (such as RAM), non-volatile memory (such as ROM, flash memory, etc.) or any combination thereof. System memory 920 may include an operating system 921, one or more applications 922, and program data 924. Application 922 may include intelligent parking management algorithm 923 that is arranged to perform the functions as described herein including the functional blocks and/or actions described. Program Data 924 may include, among many information described, database of available parking spaces 925 for algorithm 923. In some example embodiments, application 922 may be arranged to operate with program data 924 on an operating system 921 such that implementations of a smart parking system may be provided as described herein. For example, apparatus described in the present disclosure may comprise all or a portion of computing device 900 and be capable of performing all or a portion of application 922 such that implementations of intelligent parking management may be provided as described herein. This described basic configuration is illustrated in FIG. 9 by those components within dashed line 901.

Computing device 900 may have additional features or functionality, and additional interfaces to facilitate communications between the basic configuration 901 and any required devices and interfaces. For example, a bus/interface controller 940 may be used to facilitate communications between the basic configuration 901 and one or more data storage devices 950 via a storage interface bus 941. The data storage devices 950 may be removable storage devices 951, non-removable storage devices 952, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 920, removable storage 951 and non-removable storage 952 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 900. Any such computer storage media may be part of device 900.

Computing device 900 may also include an interface bus 942 for facilitating communication from various interface devices (e.g., output interfaces, peripheral interfaces, and communication interfaces) to the basic configuration 901 via the bus/interface controller 940. Example output interfaces 960 may include a graphics processing unit 961 and an audio processing unit 962, which may be configured to communicate to various external devices such as a display or speakers via one or more A/V ports 963. Example peripheral interfaces 960 may include a serial interface controller 971 or a parallel interface controller 972, which may be configured to communicate with external devices such as input devices (e.g., keyboard, mouse, pen, voice input device, touch input device, etc.) or other peripheral devices (e.g., printer, scanner, etc.) via one or more I/O ports 973. An example communication interface 980 includes a network controller 981, which may be arranged to facilitate communications with one or more other computing devices 990 over a network communication via one or more communication ports 982. A communication connection is one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

Computing device 900 may be implemented as a portion of a small-form factor portable (or mobile) electronic device such as a cell phone, a personal data assistant (PDA), a personal media player device, a wireless web-watch device, a personal headset device, an application specific device, or a hybrid device that includes any of the above functions. Computing device 900 may also be implemented as a personal computer including both laptop computer and non-laptop computer configurations. In addition, computing device 900 may be implemented as part of a wireless base station or other wireless system or device.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing device, that manipulates or transforms data represented as physical electronic or magnetic quantities within memories, registers, or other information storage devices, transmission devices, or display devices of the computing device.

Claimed subject matter is not limited in scope to the particular implementations described herein. For example, some implementations may be in hardware, such as employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon, that, when executed by a computing device, such as a computing system, computing platform, or other system, for example, may result in execution of a processor in accordance with claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a flexible disk, a hard disk drive (HDD), a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed:

1. A method for parking management, the method comprising:
receiving, at a parking management server, a request for a parking space from a client device;
determining an available parking space based, at least in part, on the received request; and
transmitting an identification of the determined available parking space to the client device.

2. The method of claim 1, wherein receiving the request comprises receiving a geographic location of the client device.

3. The method of claim 1, wherein receiving the request comprises receiving an inquiry having a location of a preferred parking space from the client device.

4. The method of claim 1, wherein determining the available vehicle parking space comprises determining an available vehicle parking space based at least in part, on a geographic location of the client device.

5. The method of claim 4, wherein determining the available vehicle parking space based at least in part, on the location of the client device comprises determining an available parking space in close proximity to the location of the client device.

6. The method of claim 1, wherein determining the available parking space comprises determining an estimated time of arrival of the client device at the available parking space.

7. The method of claim 1, wherein transmitting the identification of the determined available parking space comprises transmitting a time range when the determined available parking space is available.

8. A method for requesting a parking space, the method comprising:
transmitting a request for a parking space to a parking management server; and
receiving an identification of the determined available parking space from the parking management server, the identification based, at least in part, on the transmitted request.

9. A method for managing parking on a server, comprising:
detecting by a server a first location of a client device;
detecting by the server a second location of an open parking space; and
sending a message to the client device identifying the open parking space.

10. The method of claim 9, wherein the message includes at least one of: a status of the parking space, cost of an associated parking fee, directions to the parking space, a remuneration associated with the location of the open parking space or an indication that fees for parking in the open parking space are prepaid.

11. The method of claim 9, further comprising sending a command to a display controller proximate the open parking space to display a graphic indicating that the open parking space is reserved.

12. The method of claim 9, further comprising sending alerts to the client device indicating that a parking space is prepaid.

13. The method of claim 9, further comprising sending a coupon to the client device based on the first location or the second location or a combination thereof.

14. The method of claim 1, further comprising receiving authorization for payment for or authorizing reimbursement for payment of a parking fee associated with a reserved parking space.

15. The method of claim 14, further comprising authorizing payment for a pro-rata portion of a parking fee based on a percentage of total registered purchases.

16. The method of claim 1, further comprising receiving a signal from a sensor indicating that a vehicle is occupying a parking space and changing a parking map based on the signal.

17. The method of claim 1, further comprising determining that a parking space is occupied by a vehicle and that a fee is unpaid for a current occupant of the parking space and sending a notice to a parking enforcement device based on the determination.

18. The method of claim 17, further comprising automatically processing a fine for a parking violation by sending an alert to an enforcement entity device, receiving a command to issue a notice of a fine from the enforcement entity, issuing the notice of the fine to the client device associated with the vehicle via a communication network including at least one of the Internet, wireless communication network or at a parking meter associated with the parking space.

19. The method of claim 1, further comprising sending a message to the client device associated with a vehicle a predetermined amount of time previous to an expiration of a parking term to serve as a warning to a user to move their vehicle.

20. The method of claim 1, wherein a user may automatically reserve and/or pay for the parking space by responding to the message.
